(19) United States
(12) Patent Application Publication
(10) Pub. No.: US 2008/0094174 A1
(43) Pub. Date: Apr. 24, 2008

(54) Concealed Data Entry Device

(76) Inventors: Gordon Birtwistle, Dewsbury (GB); Paul Clancy, Leeds (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/908,869

(22) PCT Filed: Apr. 12, 2006
(86) PCT No.: PCT/GB06/01324

§ 371 Date: Sep. 17, 2007

(30) Foreign Application Priority Data
Apr. 20, 2005 (GB) 0507942.1
Jul. 5, 2005 (GB) 0513753.4

(51) Int. Cl. G07F 19/00; H04B 1/00; G07F 7/10; G07F 9/00; E05B 13/10; E05B 37/16

(52) U.S. Cl. 340/5.7; 340/5.1

(57) ABSTRACT

A data entry device is provided which includes display means for displaying data thereon and selection means for allowing a user to make one or more selections of data displayed on said display means. The display means are arranged in a substantially horizontal orientation and are recessed within a cavity or channel means defined in said device. The walls of the cavity or channel means which define an opening through which a viewer views the display means are arranged substantially perpendicular to said display means.

### FIELD OF THE INVENTION

The present invention relates to concealed data entry devices, including data entry devices for automatic teller machines and data entry devices for locking and unlocking closure members such as doors and windows.

### BACKGROUND TO THE INVENTION

Locks are used for securing closure members, such as doors and windows. Locks have a mechanism by which they can be in a locked or an open position, as selected by a user. Traditional locks use a key to co-operate with the locking mechanism to operate the lock, and for example move a bolt between a locked and an open position. In addition to locks operated by keys, there are also “keyless locks”. These have the advantage of not requiring a key to open the lock, for example, if a door to a building should remain locked to all except the personnel who work in the building, then the personnel can be given the means to open the lock. These means could be a swipe card, a combination code and so on.

There are many different types of keyless lock on the market. These include mechanical digital locks, wherein a user has to input a code to open the lock. These use mechanical actuator means to release the bolt. Electric digital locks can also be used wherein a user has to enter a code in order to open the lock. These can be powered either by batteries or by mains power. Magnetic strips can be used, wherein a user is issued with a card having a magnetic strip with coded information on the magnetic strip. By swiping the card through the magnetic strip lock, the magnetic strip lock reads whether the code is correct and opens the lock if the code is correct. Proximity locks are also available, which can work by sensing a signal from a device carried by the user. Hand readers and retinal readers are also used, wherein the signature hand print or retinal print of a user is stored in the lock, and in order for a user to open the lock its hand prints or retinal prints must match the hand print or retinal print stored in the lock.

Referring to FIG. 1, herein, there is illustrated schematically a first type of prior art digital lock. This could be a mechanical digital lock or an electric digital lock. The digital lock 101 comprises a base plate 102, a handle 103, a keypad 104 and an indicator 105. The prior art digital lock is affixed to a door, and operatively connected to a bolt. By entering the correct combination in the data entry device, in this instance a keypad 104, a user can move the bolt from a locked to an open position, thereby allowing a user to open the door. When the user has entered the correct combination in the keypad 104, an indicator light 105 is activated to show the user that the door is now unlocked and may be opened.

In another embodiment, the handle 103 is operatively connected to a sprung latch (not shown). When the door is in a locked position, the handle 103 will not turn, and therefore will not release the latch to allow the user to open the door. When the correct combination is entered into the keypad 104, then the handle 103 is released, allowing it to turn and thereby allowing the sprung latch to open and allowing the user to open the door.

In a further embodiment, the door is held shut, and so effectively locked, by an electromagnet. By entering the correct combination in the keypad 104, power is cut to the electromagnet for a predetermined period of time, thereby allowing a user to open the door.

Other types of locking mechanism are known that can be released by entering the correct combination in a keypad 104.

Digital keypads may be affixed to the door as shown in FIG. 1, or may be fixed on a wall adjacent to the door. Referring to FIG. 2 herein, there is illustrated schematically a second type of prior art digital lock. The door 201 comprises a handle 202 that must be turned by a user to release the latch (not shown), thereby allowing the user to open the door. In addition to the latch, there is a bolt (not shown) that maintains the door in a locked position. To release the bolt, the user must enter the correct combination in a keypad 203 disposed on a wall 204 adjacent to the door. The system operates in a similar manner to that described for FIG. 1.

Problems with existing mechanical and electric digital locks include the following:

The data entry device, or keypad 104, is in open view, and so when an authorized person enters the code to open the door, anyone who is not authorised to open the door can easily see the correct code being entered into the 104, and will then be able to open the lock themselves. This is a security problem.

Another problem with existing mechanical or electric digital locks is that they require either sequential or two-handed operation. For sequential operation, the code is entered into the keypad 104 to unlock the door. When the correct combination is entered the indicator 105 indicates that the door is unlocked. The user then turns the handle 103 to open the door. For two-handed operation, the user must use one hand to enter the combination into the keypad 104 and the other hand to turn the handle 103. Two-handed operation is inconvenient if the user is carrying an object when he/she wishes to open the door.

A further problem with prior art mechanical or electric digital locks is that they do not necessarily allow easy access to a door by people with certain disabilities, for example, people with visual impairment. Where the keypad 104 is not located adjacent to the handle 103, but is located on a wall 204 adjacent to the door 201, it can be difficult for a visually impaired person to find the keypad to enter the correct combination. Furthermore, not all keypads 104 comprise tactile indicators on the keys, and so the visually impaired person cannot be sure that they are entering the correct combination.

Other fields where the problem of a data entry device being seen by a third party include keypads on data entry devices, for example automatic teller machines (ATMs). The keypad is in plain view and a third party can see confidential information being entered into the keypad, such as a personal identification number (PIN). Prior art solutions include retrofitting a cover over an existing keypad, although these can be easily removed. Alternatively, a dial which is capable of rotation in a linear manner or in a two directional manner is used alone in combination with a selection button. The dial can be used to move a selector arrow on the display screen between different viewable numbers or options and the user can select a required number or option using the selection button, thereby removing the requirement for a user having to input numbers into a keypad. However, the numbers or options which the user is selecting using the dial are still typically visible to a third party and therefore the third party can still decipher a PIN or other confidential information from the screen. It is therefore desirable to find some way in which to restrict the view of data entry keypads to reduce the risk of confidential information being seen by a third party.

### SUMMARY OF THE INVENTION

The inventor has realised the problems associated with security of data entry devices, for example, for opening a door having a keyless lock or accessing an ATM. Such data entry devices are generally in view of third parties and can be easily seen. The inventor has accordingly devised an ATM that restricts the view of a data entry device, thereby increasing the security of a user's confidential details, and a lock for a closure member in which the data entry device to open the closure member is concealed by disposing it on the handle for the closure member. In one embodiment, the means to operate the locking mechanism are disposed on a surface of the handle in a concealed location, thereby preventing third parties from seeing how to operate the locking mechanism. In another embodiment the means to operate the locking mechanism comprises means to respond to a plurality of movements of the handle.

According to a first aspect of the present invention, there is provided a data entry device, said device including display means for displaying data thereon and selection means for allowing a user to make one or more selections of data displayed on said display means, characterised in that the display means are arranged in a substantially horizontal orientation and are recessed within a cavity or channel means defined in said device, the walls of the cavity or channel means which define an opening through which a viewer views the display means being arranged substantially perpendicular to said display means.

Thus, in order for a user to view the display means through an opening of said cavity or channel means, a user is required to view the display means at an angle substantially perpendicularly to said display means (i.e. in a substantially vertical orientation).

This prevents the third party from viewing the display means when in use by a user.

The walls of the cavity or channel means are of sufficient height or depth to prevent a third party from viewing the display means from a side or distance from the device. The walls defining the cavity and/or channel means can protrude outwardly from a surface in which the display means is mounted or forms part thereof or can be recessed within said surface.

The selection means can include any or any combination of one or more dials, scrolling elements, buttons, sliders, switches and/or the like.

The selection means can be used to navigate and/or move an indicator on a screen on the display means between two or more different positions and/or can be used to make a selection once the indicator is in a required location on said display means.

Preferably the selection means includes a selector element which is capable of undergoing movement in one of a plurality of arbitrary user selectable paths, such as in a non-linear manner, in three dimensions (i.e. about X, Y and Z axes), in more than two positions, is rotatably mounted and/or the like. By providing the selection means to move in a plurality of user selectable directions, it makes it more difficult for a third party to correlate movement of the selection means with selection of data on the display means.

In a preferred embodiment the selection means includes a ball or hemispherical member mounted on or associated with said device, which can be rotated in more than one direction, and preferably a plurality of directions, such as in three dimensions, to allow selection of data displayed on the display means. The ball or hemispherical member can be mounted on a suitable surface of the device in use. The ball or hemispherical member typically navigates an indicator around a screen on the display means and this or a separate selector button or selection means can be used to make a selection once the indicator is in a suitable place on the screen.

The data entry display device is typically an electrical device and the display means is typically in the form of a display screen.

In one embodiment the data entry device is provided on or associated with an automatic teller machine (ATM). A card entry port, cash dispensing port and/or other features can be provided on or in association with the data entry device. This aspect of the present invention has the advantage of removing the problems associated with having an exposed keypad on an ATM or pin & chip machine.

In an alternative embodiment the data entry device is provided on or associated with a handle of a closure member or door.

The data displayed on the display means can be scrambled or randomly changed (i.e. the position of one or more data items displayed on the display means can be changed) after each use via processing means forming part of or associated with said device and/or moved about on selection of a data item using the selection means, such that a user is required to undertake different movements using the selection means for selecting data items on the display means. Thus, movement of the selection means by a user appears arbitrary or random to a third party looking at a user inputting data into the data entry device.

Thus, according to separate aspects of the present invention there is provided an ATM with data entry device; and a handle for a closure member with data entry device.

According to a second aspect, there is provided a data entry device for an automatic teller machine, the automatic teller machine includes a screen configured to display information, a card entry port, a hand rest, and the data entry device including a keypad, the keypad including a plurality of keys, said keys being configured to allow a user to enter data characterised in that said data entry device is disposed at said hand rest and substantially facing said screen, or disposed substantially at a lower surface of said hand rest thereby restricting a view of said data entry device.

In whichever embodiment, the data entry device faces away from a user of the same so as to restrict the view of a third party viewing the data entry device.

Preferably, the hand rest comprises or includes a bar.

Preferably, the automatic teller machine further includes a reflective surface, the reflective surface configured to allow a user to see the keypad.

Alternatively, the automatic teller machine further includes a camera, the camera being configured to capture an image of the data entry device; a viewing port, the viewing port being operatively connected to the camera and configured to display the captured image; wherein a view of the captured image is apparent to a single user only.

Alternatively, the data entry device is mounted at a pivoting drum, the data entry device configured to move between a visible position and a concealed position substantially facing the screen.

Preferably, the automatic teller machine further includes at least one projecting stud disposed in proximity to the card entry port, the stud configured to restrict a fitting of a dummy cover.

Preferably, the stud includes a trapezoidal cross section.

Preferably, an upper surface of the stud is disposed substantially above the card entry port.

According to a third aspect there is provided a handle for a closure member, the closure member including a locking mechanism, the handle including means for operating the locking mechanism characterized in that the means for operating the locking mechanism is disposed on a surface of the handle, the surface of the handle substantially facing the closure member or facing away from a user of the closure member.

For example, the means for operating the locking mechanism could be located on a surface facing the closure member, on a base surface of the handle, on an angled surface facing away from the user and/or the like.

Preferably, the means for operating the locking mechanism includes a plurality of elements, the elements configured to co-operate in combination to operate the locking mechanism.

Preferably, the elements are selected from a set including any or any combination of one or more buttons, sliders, dials, switches, direction dials and/or the like.

Preferably, the elements are configured to be operated sequentially.

Alternatively, the elements are configured to be operated simultaneously.

Preferably, the handle further includes a projecting lug configured to partially cover the means for operating the locking mechanism.

Preferably, the means for operating the locking mechanism includes tactile indicators, the tactile indicators configured to impart information about the means for operating the locking mechanism.

Preferably, the tactile indicators are chosen from a set including any or any combination of a raised profile, surface finish, raised Braille profile and/or the like.

Preferably, the locking mechanism includes a bolt configuration to selectively lock the closure member in a closed position.

Alternatively, the locking mechanism includes means to selectively restrict operation of the handle.

Preferably, the means for operating the locking mechanism includes at least one mechanical actuator.

Alternatively, the locking mechanism includes at least one electronic actuator.

Preferably, the handle for a closure further includes a secondary device configured to restrict operation of the locking mechanism unless the secondary device is actuated, the secondary device being selected from any or any combination of a button, a touch pad, a swipe card reader, identification technology, logistics, a proximity device such as a radio transmitter and/or the like.

According to a fourth aspect, there is provided a handle for a closure member, the closure member having a locking mechanism including means for operating the locking mechanism and further including means to respond to a plurality of movements of the handle, wherein the locking mechanism is configured to be operated in response to the plurality of movements of the handle corresponding with a predetermined plurality of movements of the handle.

Preferably, the predetermined movements are selected from any or any combination of rotation of the handle about an axis substantially perpendicular to a main plane of the closure member, rotation of the handle about an axis substantially parallel to a main plane of the closure member, movement of the handle in a direction substantially perpendicular to a main plane of the closure member and/or the like.

Preferably, the means for operating the locking mechanism includes at least one mechanical actuator.

Alternatively, the means for operating the locking mechanism includes at least one electronic actuator.

According to a fifth aspect, there is provided a handle for a closure member including a combination lock, the combination lock being disposed at a surface of the handle substantially facing the closure member, and the combination lock configured to selectively operate a locking mechanism for the closure member.

Preferably, the combination lock includes a plurality of elements, the elements selected from any or any combination of one or more buttons, sliders, switches, dials, direction dials and/or the like.

Preferably, the locking mechanism includes a bolt.

Alternatively, the locking mechanism includes means to selectively restrict operation of the handle.

According to a sixth aspect, there is provided a door including a locking mechanism, a handle, means for operating the locking mechanism, characterized in that the means for operating the locking mechanism is disposed at a surface of the handle, the surface of the handle substantially facing the door or facing away from a user of the door.

The handle can include any type of user actuation means to allow user access to the door.

Preferably, the means for operating the locking mechanism includes a plurality of elements, the elements configured to co-operate in combination to operate the locking mechanism.

Preferably, the elements are selected from a set including any or any combination of one or more buttons, sliders, dials, switches, direction dials and/or the like.

Preferably, the elements are configured to be operated sequentially.

Alternatively, the elements are configured to be operated simultaneously.

Alternatively, the means for operating the locking mechanism includes means to respond to a plurality of movements of the handle wherein, the locking mechanism is configured to be operated in response to the plurality of movements of the handle corresponding with a predetermined plurality of movements of the handle.

Preferably, the predetermined movements are selected from any or any combination of rotation of the handle about an axis substantially perpendicular to a main plane of the closure member, rotation of the handle about an axis substantially parallel to a main plane of the closure member, movement of the handle in a direction substantially perpendicular to a main plane of the closure member and/or the like.

### BRIEF DESCRIPTION OF THE DRAWINGS

For a better understanding of the invention and to show how the same may be put into effect, there will now be described by way of example only, specific embodiments, methods and processes according to the present invention with reference to the accompanying drawings in which:

FIG. 1 illustrates schematically a first type of prior art digital lock.

FIG. 2 illustrates schematically a second type of prior art digital lock.

FIG. 3 illustrates schematically a perspective view of a handle and back plate according to a first specific embodiment.

FIG. 4 illustrates schematically a rear elevation view of a handle and back plate according to a first specific embodiment.

FIG. 5 illustrates schematically a plan view of a cross section through a door showing two handles and a locking bolt according to the first specific embodiment.

FIG. 6 illustrates schematically a perspective view of a door showing two handles and a locking bolt according to the first specific embodiment.

FIG. 7 illustrates schematically examples of elements for entering a code.

FIG. 8 illustrates schematically examples of tactile indicators for elements for entering a code.

FIG. 9 illustrates schematically examples of handle movements.

FIG. 10 illustrates schematically an automatic teller machine (ATM).

FIG. 11 illustrates schematically a cross-section view of an ATM having a pivotally mounted keypad.

FIG. 12 illustrates schematically a cross-section view of an ATM having studs fitted to a surface of the ATM.

FIG. 13 illustrates schematically an ATM comprising a trough with a keypad disposed in the trough.

FIG. 14 illustrates schematically an ATM having a viewing port.

FIG. 15 illustrates an ATM according to one embodiment of the present invention.

FIG. 16 illustrates a Pin and Chip Card Machine according to a further embodiment of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well-known methods and structures have not been described in detail so as not to unnecessarily obscure the description.

Throughout this description, reference will be made to a door for the sake of clarity. However, the invention can be applied equally to other closure members, for example, exterior or interior doors, car doors, garage doors, windows, safe doors and so on.

Furthermore, reference is made throughout the description to a handle. This applies to handles including lever handles, which actuate a latch when turned, knobs, pull handles (such as those found on car doors or filing cabinets).

Furthermore, reference is made throughout to a locking mechanism. A locking mechanism is distinct from a latch, in that a latch is configured to hold a door in a closed position, but to be released simply by turning a handle or performing a similar operation. A locking mechanism on the other hand is a mechanism that is configured to lock a door in a closed position, and requires a separate operation to operate and unlock. A locking mechanism can include, but is not limited to, a separate bolt from the latch, or means to restrict movement of the latch.

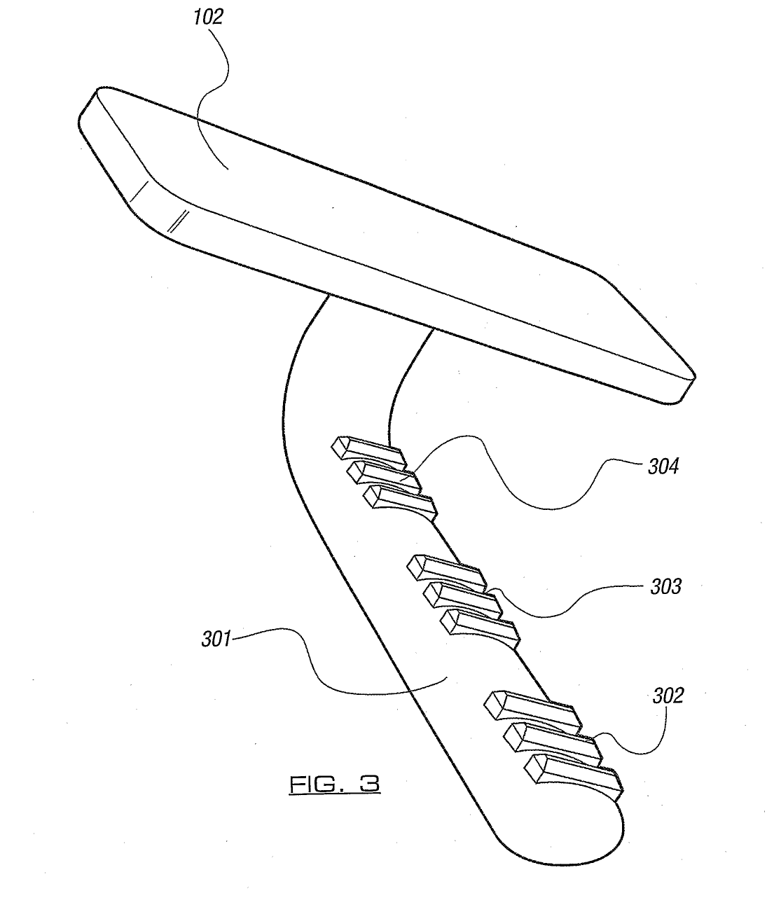

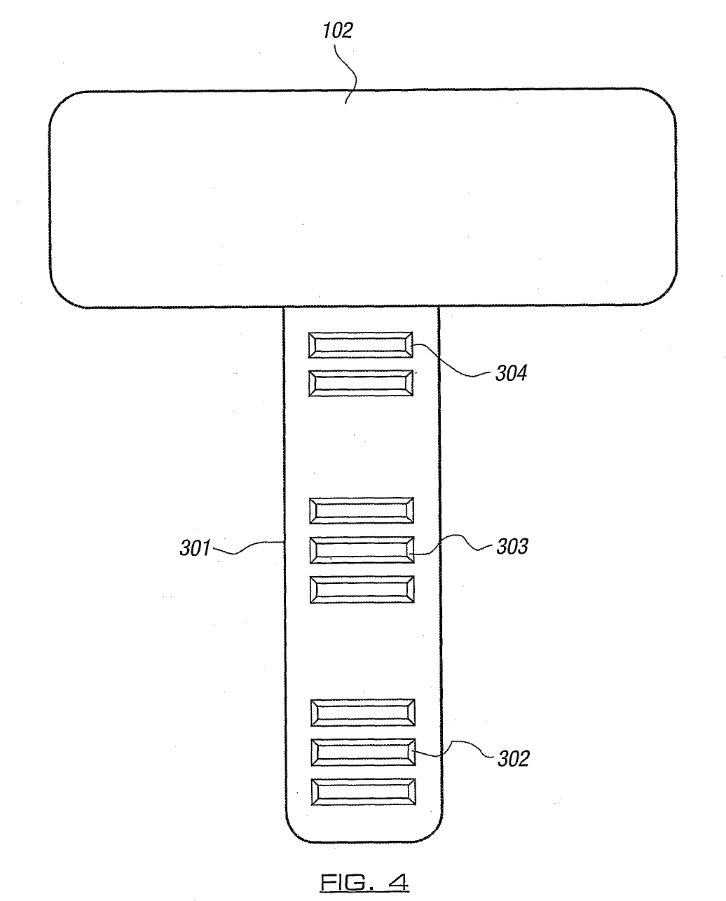

Referring to FIG. 3 herein, there is illustrated schematically a perspective view of a handle and back plate according to the first specific embodiment. Referring to FIG. 4 herein, there is illustrated schematically a rear elevation view of a handle and back plate according to the first specific embodiment. The back plate 102 is configured in use to be affixed to a door. A handle 301 is provided. The handle 301 shown is a lever-type of handle. The handle 301 is operatively connected to a latch (not shown) in the door. The latch co-operates with an orifice in a doorframe such that when the latch is extended the door remains closed, and when the latch is retracted the door can be opened. When the handle 301 is in a first position, the latch is in its extended position. When a user wishes to open the door, he rotates the handle 301 such that the latch retracts and allows the door to be opened.

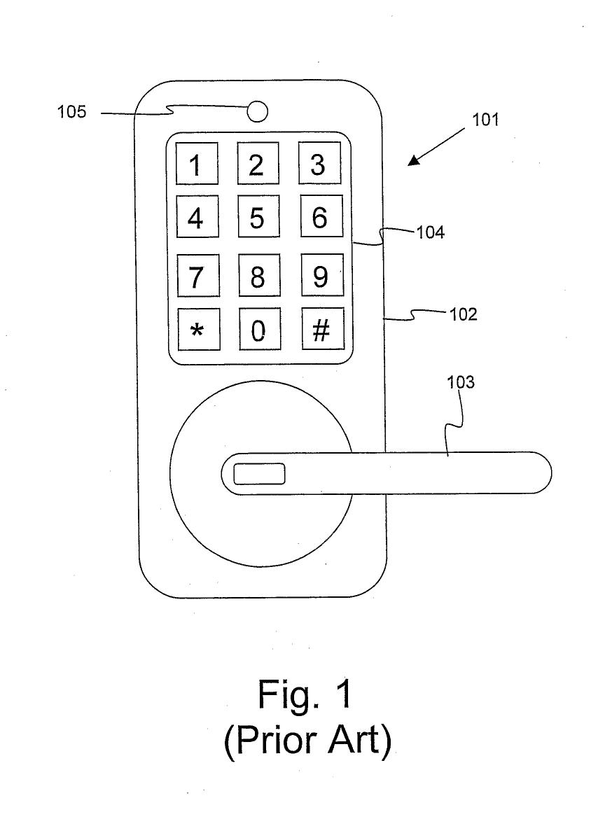

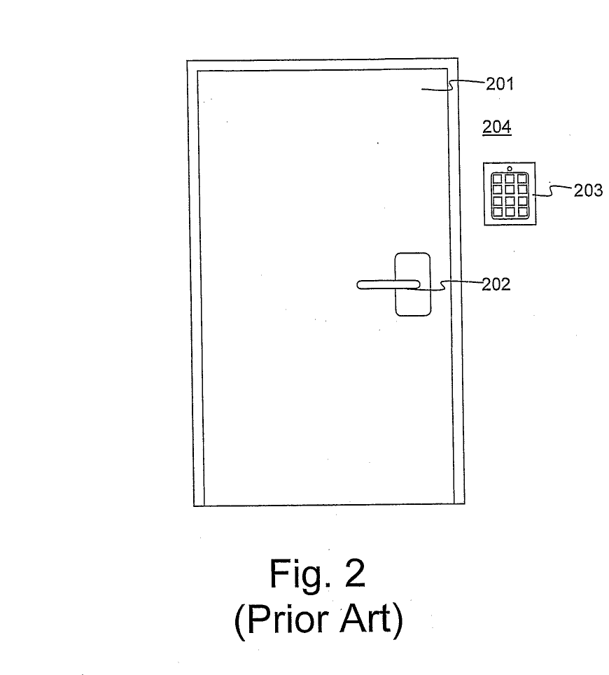

The handle 301 further comprises means 302, 303, 304 for operating a locking mechanism. The locking mechanism (not shown in FIG. 1) allows a user to selectively lock or unlock a door. Typically the locking mechanism comprises a prior art locking mechanism such as a bolt that extends from the leading edge of the door into an orifice in the frame, and electromagnet disposed to hold the door to the frame when current is passed through the electromagnet, or means to immobilize the handle 301 such that it cannot be turned to retract the latch.

The means 302, 303, 304 for operating a locking mechanism in the first embodiments comprises a first set 302 of three elements, a second set 303 of three elements and a third set 304 of three elements. The elements in this embodiment are buttons.

The buttons 302, 303, 304 are disposed on a surface of the handle 301 that faces the door. This is for two reasons; the first is that it allows simple one-handed operation of the buttons. When a user grasps the handle 301, his fingers are placed over the buttons 302, 303, 304 in a position to press the buttons 302, 303, 304. In this way, a user can enter a code using the buttons 302, 303, 304 to unlock the door, and then turn the handle 301 to open the door without moving his hand. The second reason for disposing the buttons 302, 303, 304 on a surface of the handle that faces the door is security. If the user's hand is grasping the handle whilst entering the code, it is much more difficult for a third party to see the code that is entered, and therefore makes it less likely that unauthorized persons will be able to ascertain the code. This is because the third party's view of the buttons 302, 303, 304 is restricted as the code is being entered.

The buttons 302, 303, 304 are configured to operate the locking mechanism to unlock the door only if a predetermined code is entered using the buttons 302, 303, 304. In this way unauthorized persons cannot unlock the door, as they will not know the code required.

The correct code may be entered by pressing preselected buttons in the correct sequence. For example, the code to operate the locking mechanism may be pressing the second button from the first set of buttons 301 followed by the third button from the third set of buttons 304 followed by the second button from the second set of buttons 303. This type of sequential operation gives many different permutations to give many different codes that may be correct (729 possible codes in the example shown).

Alternatively, the correct code may be entered by simultaneously holding down the required buttons, although this gives fewer permutations of code.

The elements 302, 303, 304 disposed on the handle 301 effectively perform the same function as a keypad 104 that is disposed in proximity to the handle in prior art keyless locks.

The locking mechanism is operated by the elements 302, 303, 304 by either mechanical means, electrical means or a combination of electrical and mechanical means. For example, depressing the elements 302, 303, 304 in the correct code may mechanically actuate a bolt causing it to retract, thereby unlocking the door. Alternatively, the elements 302, 303, 304 may form electrical contacts with a circuit such that entering the correct code on the buttons activates an electric actuator that unlocks the door. A combination of electric and mechanical means can be used to actuate the locking mechanism.

Where electrical means are used to actuate the locking mechanism, power is provided from a battery or from a mains power source. Where power is provided by a mains power source, it is desirable to have a backup battery in place to ensure that the electrical means to actuate the locking mechanism can still be used in the event of a power cut. A backup battery may be rechargeable to ensure that it remains charged as long as a mains power source is active.

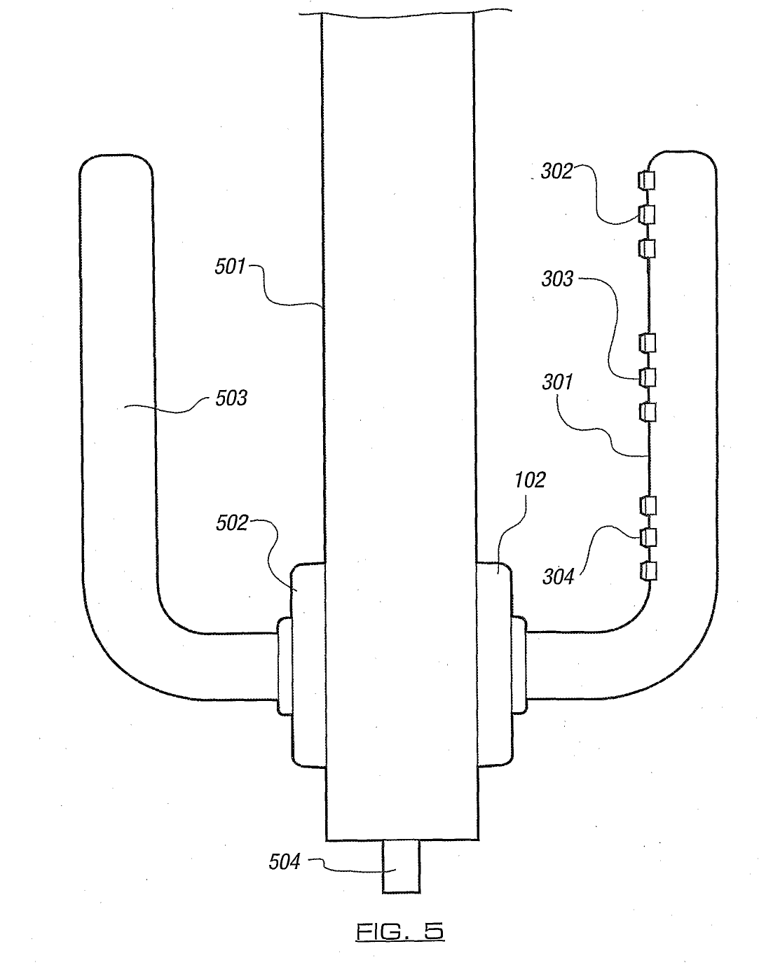

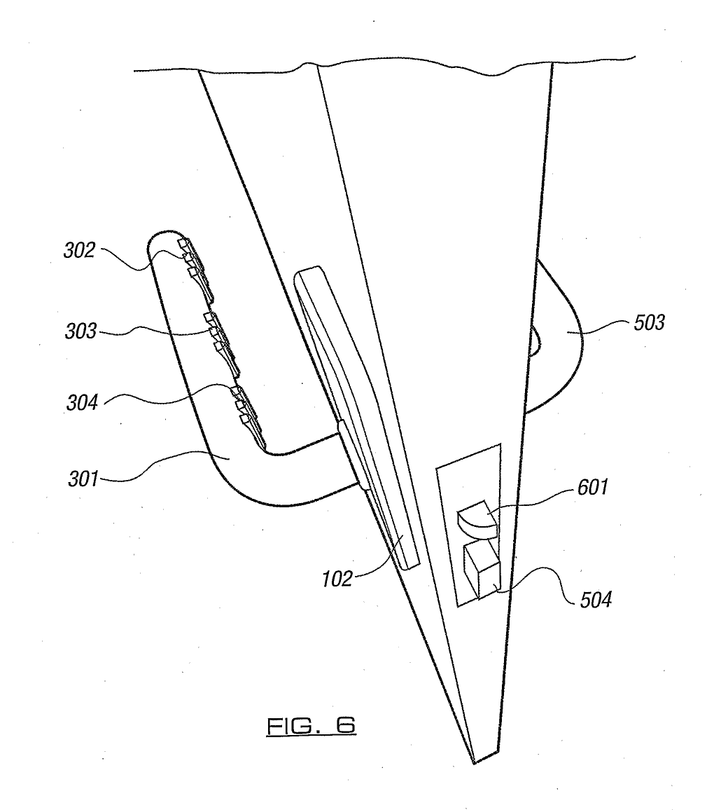

Referring to FIG. 5 herein, there is illustrated schematically a plan view of a cross section through a door showing two handles and a locking bolt according to the first specific embodiment. Referring to FIG. 6 herein, there is illustrated schematically a perspective view of a door showing two handles and a locking bolt according to the first specific embodiment. The door 501 has an outer face on which the back plate 102 and the handle 301 is disposed. It is the outer face that has restricted entry. A user cannot open the door from the side of the outer face without knowing the code to enter in the elements 302, 303, 304. The door 501 also has an inner face on which a second back plate 502 is disposed, and a second handle 503 is disposed extending from the second back plate 502.

The second handle 503 does not comprise elements by which a user enters a code to operate the locking mechanism, as if the user is on the inner face side of the door 501 then they should already be authorized to be able to operate the locking mechanism.

A locking button (not shown) may be provided on the second handle 503. When the locking button is depressed, then the elements 302, 303, 304 on the handle 301 are active so that the door can only be opened by a user who knows the code to operate the locking mechanism. When the locking button is released then the elements 302, 303, 304 are not active such that the door remains unlocked and can be opened by anyone from the outer face or the inner face side of the door without necessarily knowing the code to activate the locking mechanism.

A locking button is not necessary, but if one is required then an alternative to a locking button is to raise the second handle 503 to deactivate the elements 302, 303, 304. Other methods of deactivating the elements may also be used.

In this embodiment a bolt 504 is shown that comprises part of the locking mechanism. The bolt is shown extended such that it would co-operate with a bolt orifice in a doorframe to lock the door. When the locking mechanism is operated then the bolt 504 is retracted to unlock the door.

A latch 601 is also shown. The latch is biased towards an extended position such that it co-operates with a latch orifice in the doorframe to keep the door shut. By lowering either handle 301, 503, the latch is retracted allowing the door to open.

In the embodiment shown, the latch is not part of the locking mechanism. However, in an alternative embodiment a bolt 504 is not provided, but the means to operate the locking mechanism comprises means to selectively restrict operation of the handle 301. That is to say, if the correct code is not entered into the elements 302, 303, 304 then the handle 301 cannot be lowered and so the latch cannot be retracted, thereby effectively maintaining the door in a locked position.

To reduce the risk of unauthorized entry, the back plate 102 cannot be removed from the door 501 as no attaching screws are used. The back plate 102 is secured to the door 501 by bolts from the second back plate 502. In this way, access to the locking mechanism can only be obtained by removing the second back plate 502 from the inner face of the door 501. Access to the locking mechanism is required for maintenance or repair of the locking mechanism, or for changing or resetting the code required to operate the locking mechanism.

In some circumstances a person who knows the correct code to operate the locking mechanism may inadvertently enter the wrong code. To this end, a reset mechanism is provided that clears the previous code entered and allows the user to re-enter the correct code.

Several different types of reset mechanism may be used. These include a separate reset button, a facility that allows the handle 301 to be pulled away from the door 501 and then returned to its usual position, or lifting the handle 301 upwards.

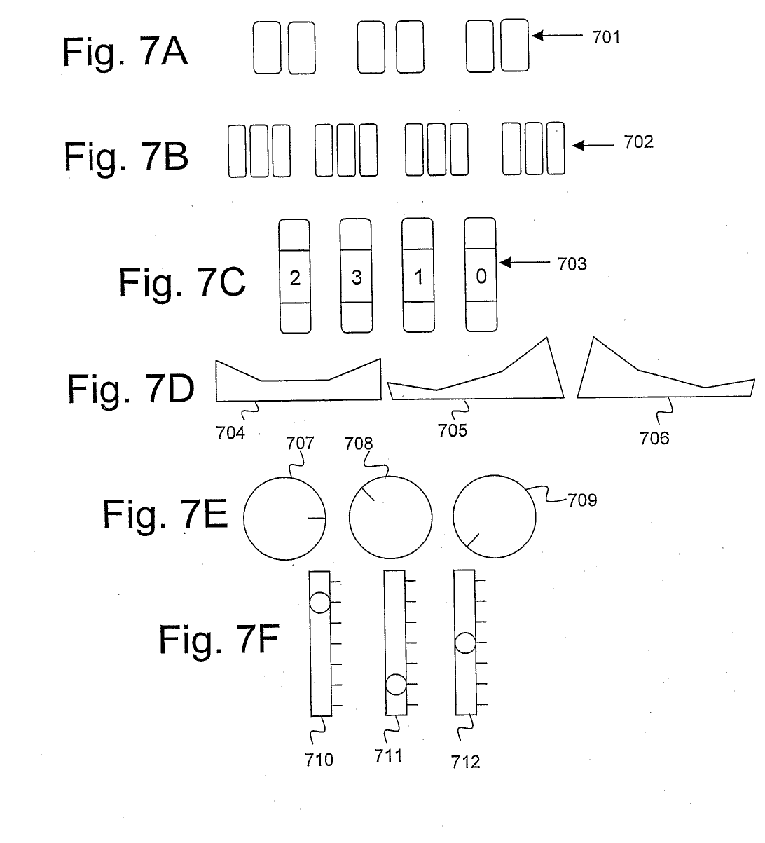

In alternative embodiments, different types of elements may be used for entering the code. Referring to FIG. 7 herein, there is illustrated schematically examples of elements for entering a code.

FIG. 7A shows 6 buttons 701, giving 216 permutations for a three-digit code or 1296 permutations for a four-digit code. The buttons are grouped into three groups of two to allow a user to easily identify the correct buttons are in the correct position. Alternatively, the groupings may add a further layer of complexity to the permutations of code. The correct buttons must be pressed in the correct sequence in order to operate the locking mechanism.

FIG. 7B shows twelve buttons 702, giving 1728 permutations for a three-digit code or 20,736 permutations for a four-digit code. The buttons are grouped into four groups of three to allow a user to easily identify the correct buttons are in the correct position. Alternatively, the groupings may add a further layer of complexity to the permutations or code. The correct buttons must be pressed in the correct sequence in order to operate the locking mechanism.

FIG. 7C shows a digital type 703 of combination that is commonly seen on combination locks for padlocks or briefcases. The correct code must be entered on the dials. Each dial must therefore be in the correct position to operate the locking mechanism. Where four dials having ten positions are used, as shown in FIG. 7C, there are 10,000 permutations of code that may be used.

FIG. 7D shows a switch-type of element. A required number of switch type elements can be used. In the example shown in FIG. 7D, each switch has three positions; a first position 704, a second position 705 and a third position 706. Each switch must be in the correct position in order to operate the locking mechanism. Where four such switches are used there are 81 different permutations of code.

FIG. 7E shows a series of direction dial type of elements. Direction dials allow a user to rotate each dial 707, 708, 709 to required positions, and the locking mechanism is only operated when each direction dial is in the correct position. In the example shown in FIG. 7E, three direction dials are provided each having eight possible positions, giving a total of 512 permutations of code.

FIG. 7E shows a series of slider type of element. Each slider in this example has seven discrete positions. Each slider must be in the correct position to operate the locking mechanism. Where three such sliders are provided there are 343 different permutations of code.

It will be apparent that other types of element may be used, and that combinations of different types of element may be used.

A disadvantage of this type of system is that it requires a user to be able to see the code that has been entered. This is a disadvantage because where the elements are disposed on a surface of the handle 301 facing the door, it is difficult for a user to see which elements are in which position. Additionally, where a visually impaired person requires access they will not be able to easily distinguish the elements.

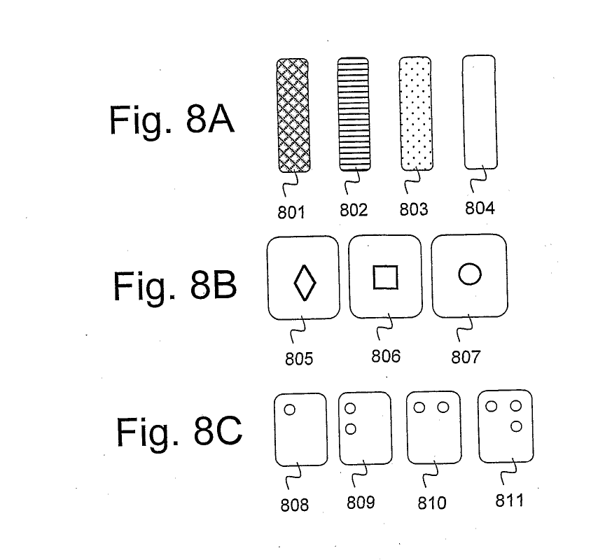

Referring to FIG. 8 herein, there is illustrated schematically examples of tactile indicators for elements for entering a code. The elements shown comprise buttons, although it will be apparent that tactile indicators can be equally used on other types of elements.

FIG. 8A illustrates a plurality of buttons having different surface finishes. Different surface finishes include knurling 801, stripes 802, dimples 803 or a smooth finish 804. Other types of surface finish may also be used. The surface finish allows a user to distinguish between different elements using touch alone. In this way, a user could think of the code to operate the locking mechanism as, for example, “smooth, knurled, striped, knurled”.

FIG. 8B illustrates a plurality of buttons having different raised profiles. Raised profiles may include easily distinguishable shapes such as a diamond 805, a square 806, or a circle 807. Again, the raised profile allows a user to distinguish different buttons by the way they feel.

FIG. 8C illustrates a plurality of buttons having different raised Braille profiles. This is of particular relevance to visually impaired users. The raised Braille profile allows buttons to be distinguished by letters or numbers using touch. In the example shown in FIG. 8C, the buttons have Braille symbols for A 808, B 809, C 810 and D 811.

Where the elements are disposed on the handle, it is advantageous to provide a projecting hood disposed over the elements to partially shield them from atmospheric conditions. This is particularly advantageous where the handle is disposed on a surface of a door on the outside of a building, as the projecting hood can partially shield the elements from the effects of rain and other weather conditions.

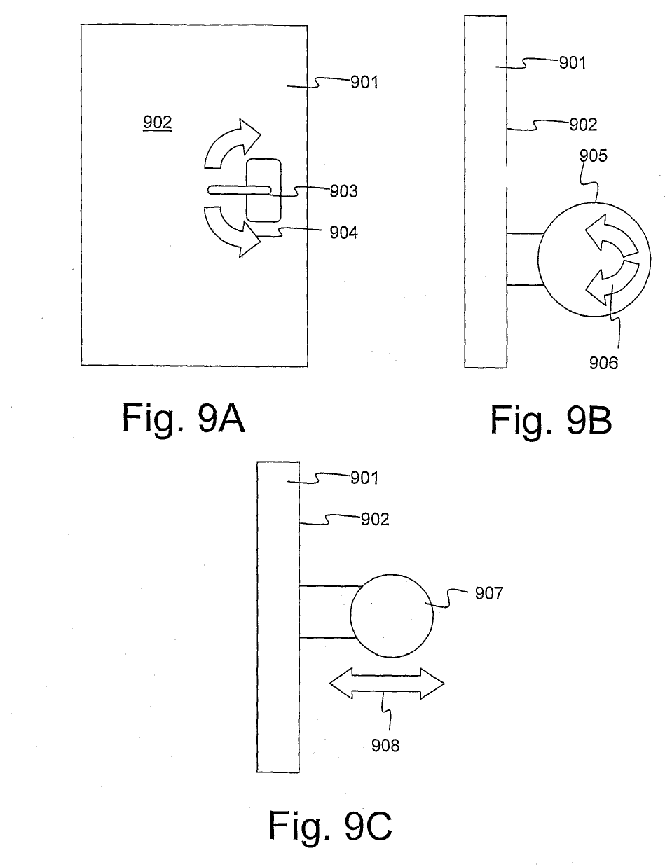

In a further embodiment, the means for operating the locking mechanism comprises means to respond to a plurality of movements of the handle. Referring to FIG. 9 herein, there are illustrated schematically examples of handle movements.

Instead of having elements such as buttons disposed on a surface of the handle, a code can be entered directly using the handle itself, and the locking mechanism can be operated if the entered code corresponds with a predetermined code. The code is entered by moving the handle.

FIG. 9A shows rotation of the handle about an axis substantially perpendicular to a main plane of the door. The door 901 comprises a main plane 902 of the face of the door 901. The handle 903 can be moved 904 by rotating it about an axis substantially perpendicular to the main plane 902 of the door 901. The locking mechanism is configured to be operated in response to movements of the handle. Each rotation may be a discrete amount. Indications such as audio clicks can notify the user how many discrete amounts the handle has been rotated. For example, by turning the handle upwards for two clicks, down for three clicks, upwards again for one click and down for a further two clicks, the locking mechanism can be operated. The precise code required to operate the locking mechanism is predetermined, and the code entered by the user in the form of handle movements must correspond with the predetermined movements required to operate the locking mechanism.

Other types of handle movement are illustrated in FIGS. 9B and 9C. However, these types of movement may also be used to operate the locking mechanism.

FIG. 9B illustrates rotation 906 of the handle 905 about an axis substantially parallel to the main plane 902 of the door 901. This type of movement is similar to a method of changing gears on a bicycle using the handlebars. The user grasps the handle and rotates it either clockwise or anti-clockwise in a predetermined code.

FIG. 9C illustrates linear movement 908 of the handle 907 in a direction substantially perpendicular to the main plane 902 of the door 901. By pulling or pushing the handle relative to the door, a code may be entered.

The locking mechanism described with reference to FIGS. 9A, 9B and 9C may be operated mechanically where, for example, entering the code using the handle 903 allows tumblers to fall into place thereby releasing the locking mechanism.

Alternatively, the locking mechanism may be operated electrically where, for example, the code entered using the handle is analyzed digitally and the locking mechanism is operated using an electrical actuator if the code entered corresponds with the correct code for operating the locking mechanism.

Where the means for operating the locking mechanism comprises means to respond to a plurality of movements of the handle, different styles of handle may be used. A lever type of handle is particularly suitable where the handle 905 is rotated 906 about an axis substantially parallel to the main plane 902 of the door 901. Lever or knob types of handle are particularly suitable where the handle 903 is rotated 904 about an axis substantially parallel to the main plane 902 of the door 901, or where the handle 907 is moved in a direction substantially perpendicular to the main plane 902 of the door 901.

According to a further specific embodiment, a further operation is required to operate the locking mechanism. This further operation includes, but is not limited to, any or any combination of an operating button, operating a touch pad, use of a swipe card, use of a fob tag of a key, use of identification technology, such as fingerprint recognition technology, use of logistics, automatic operation in response to a proximity device such as a radio transmitter and/or the like.

If a user performs the further operation without having first entered a predetermined code, then the locking mechanism will not be operated. This type of locking mechanism may be used on, for example, a car door in which a combination of entering the correct code and having the correct key fob will open the door.

In a further specific embodiment, each user has a personal code unique to that user. By entering their code, the locking mechanism may or may not be operated depending on whether that user is permitted to operate that locking mechanism. Thus, a first user may have their own personal identification number (PIN), and a second user may also have their own personal PIN, which is different to the first user's PIN. If the first user has clearance to access a door, but the second user does not have clearance to access that door, then the first user's PIN will operate the locking mechanism, but the second user's PIN will not operate the locking mechanism.

A further specific embodiment that utilizes concealed locking elements is in automated teller machines (ATMs) and similar devices that require data to be entered via a keypad. Other such devices include, but are not limited to, point of sale PIN entry devices.

ATMs require a user to enter a code such as a personal identification number (PIN) and to enter instructions. The PIN and instructions are entered through a keypad on the ATM, which for prior art ATMs is in view of third parties other than the user of the ATM. The user therefore risks a third party being able to find their details such as a PIN number or the amount of money being deposited or withdrawn.

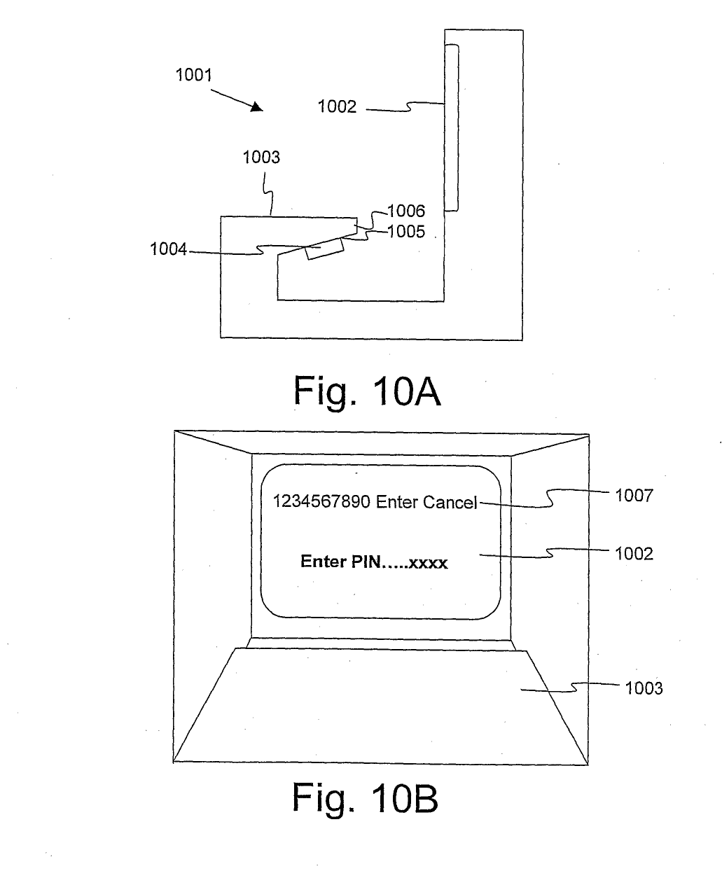

Referring to FIG. 10A herein, there is illustrated schematically a cross-section view of an ATM according to this specific embodiment. The ATM 1001 comprises a screen 1002 to provide the user with information, a hand rest 1003 on which a user can rest his or her hand, and a plurality of keys 1004. The keys 1004 are disposed on a lower surface 1005 that is situated below the hand rest 1003.

Referring to FIG. 10B herein, there is illustrated schematically a view of the ATM from the perspective of a user. The only parts of the ATM that are visible are the hand rest 1003 and the screen 1002. In use, the user places his/her hand on the hand rest 1003. The user's fingers are positioned such that they curl over the edge 1006 of the hand rest and come into contact with the keys 1004. The keys are disposed in a row along the lower surface 1005. The keys 1004 may comprise tactile indicators as described above. The screen 1002 displays a key map 1007 that shows the user the relative position of the keys 1004 on the lower surface 1005 to assist the user in quickly identifying the correct keys.

The keys 1004 can be used for any type of data input. Examples of the type of operations that can have keys 1004 assigned to them include, but are not limited to, the following numerical data input for, for example, entering a PIN or a value, cancelling a transaction, confirming a transaction and/or the like.

By disposing the keys below a hand rest, a third party cannot see which keys are being pressed. In this way, a user's PIN can remain confidential as it is entered through the keys 1004. Other aspects of a transaction, such as entering a value of money, cancelling a transaction, confirming and so on are also entered using the concealed keys 1004.

An ATM using these keys 1004 can be made to be triple data encryption standard (TDES) compliant, an industry standard algorithm for encrypting PINs, and for VISA ATMs should be compliant with VISA security requirements.

In an alternative specific embodiment, the keys 1004 are disposed substantially at a surface of a bar and facing substantially towards the screen 1002 to prevent a third party from seeing which keys are being pressed. The bar may be disposed at any suitable angle. Suitable angles include the disposition of a bar such that its longitudinal axis is substantially horizontal or such that its longitudinal axis is substantially vertical. The bar need not necessarily be linear along its full length but can be shaped and angled to provide a comfortable grasp for the user that allows the user to intuitively identify the key required.

In a further specific embodiment, the ATM includes disabled function keys to ensure compliance with both the Americans Disability Act and they UK Disability Discrimination Act.

Disabled function keys can include keys having, for example, Braille profiles to assist a visually impaired user. Disabled function keys can be included as part of a secondary keypad, the ATM further comprises means to alert the ATM if a disabled or visually impaired person is using the machine, thereby enabling the disabled function keys.

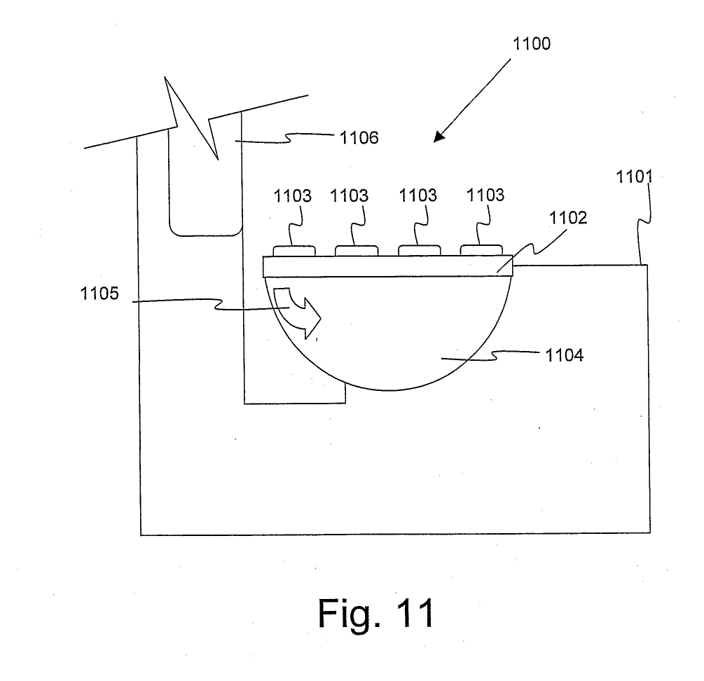

In a further specific embodiment, a numeric keypad is pivotally mounted on a surface of an ATM. Referring to FIG. 11 herein, there is illustrated schematically a cross-section view of an ATM having a pivotally mounted keypad. The ATM 1100 comprises a hand rest 1101 and a data entry device in the form of a keypad 1102. The keypad 1102 comprises a plurality of keys 1103 and is disposed at the hand rest 1101. The keypad 1102 is mounted on a pivotally moveable drum 1104. The drum can pivot as shown by arrow 1105 such that the keypad can be angled substantially towards a user or substantially towards a screen 1106, and hence away from a user.

In this way, a user can see the keypad 1102 and the position of the keys 1103 when the keypad 1102 is angled towards the user. Once the user has seen the position of the keys 1103, the drum 1104 is rotated such that the keypad 1102 substantially faces the screen 1106, and is therefore more difficult for third parties to see. The restricted view of the keypad 1102 provides more security for a user's PIN. The keypad is therefore configured to move between a visible position relative to a user and a concealed position relative to a user.

A further advantage of having a pivoting drum 1104 on which a keypad 1102 is mounted is that it restricts fitting of a cover. A way of defrauding an ATM is to fit a cover having a dummy keypad that records keystrokes on the keypad, and hence a PIN, and a dummy card entrance that records card details. Dummy covers can look extremely convincing. However, having a pivoting keypad 1102 restricts the fitting of a dummy cover.

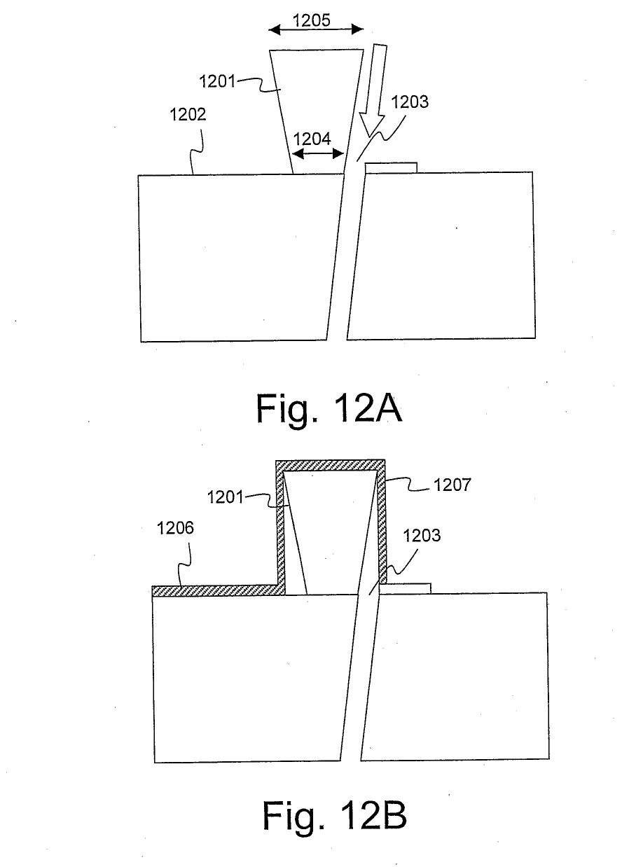

A further way to restrict fitting a dummy cover is to provide chamfered studs as part of an ATM. Referring to FIG. 12A herein, there is illustrated schematically a cross-section view of an ATM having studs fitted to a surface of the ATM. A stud 1201 is provided ostensibly as a decorative feature. However, its function is to restrict the fitting of a dummy cover. The stud 1201 is disposed on a surface 1202 of the ATM in close proximity to a card entry port 1203. The stud is chamfered such that a surface width 1204 of the stud 1202 disposed on the surface 1202 is less than an opposite width 1205 of the stud 1201 opposing the surface 1202. The stud can be of any suitable shape that fits these criteria. An example of such a shape would be an inverted truncated cone. In any case, a shape having a trapezoidal cross-section is suitable.

More than one chamfered stud 1201 can be provided at different regions of the ATM.

If a dummy cover were to be fitted to the ATM, it would be apparent to a user that a dummy cover was in place on the ATM as the chamfered studs would no longer look chamfered, but straight-walled. For example, where the chamfered studs have the shape of an inverted truncated cone, the dummy cover would need to be cylindrical to cover the chamfered studs. Referring to FIG. 12B herein, there is illustrated schematically a cross-section view of an ATM having studs fitted to a surface of the ATM with a dummy cover placed over the stud.

The dummy cover 1206 has a cross-section to fit over the opposite width 1205 of the stud 1201, and therefore does not have angled walls 1206. As the walls 1206 are not angled, they block off the card entry port 1203 owing to the proximity of the stud 1201 to the card entry port 1203. This prevents a user from being able to use the ATM if a dummy cover is fitted, thereby reducing ATM fraud. The card entry port 1203 is blocked off because the opposite width 1205, or upper surface of the stud 1201, is disposed above the card entry port 1203.

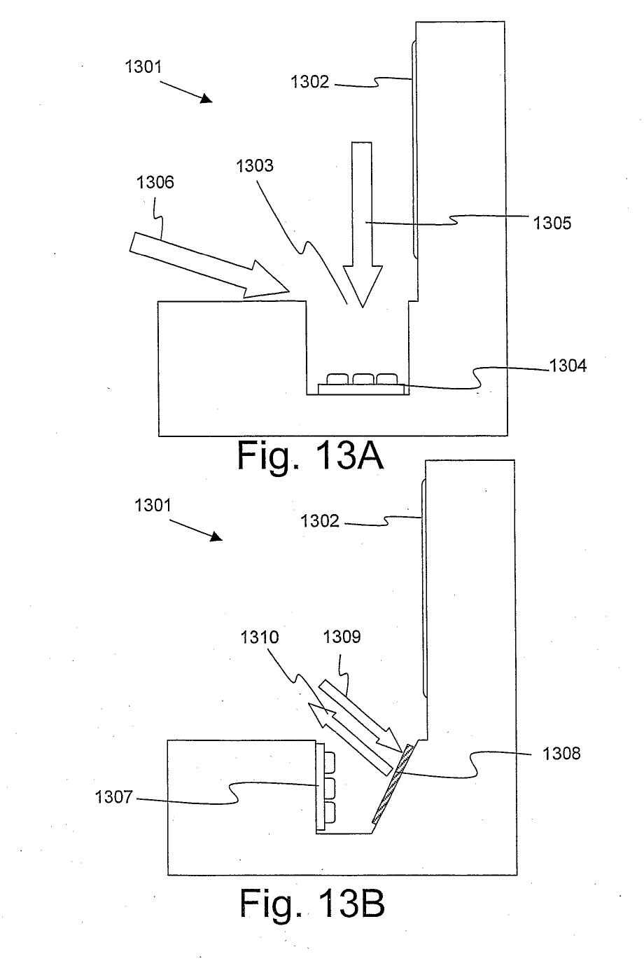

In a further specific embodiment, a keypad for an ATM is disposed in a trough on a surface of the ATM. Referring to FIG. 13A herein, there is illustrated schematically an ATM comprising a trough with a keypad disposed in the trough. The ATM 1301 comprises a screen 1302 configured to provide a user with information, a trough 1303 at the ATM having a base, the base being substantially perpendicular to the main plane of the screen 1302. A data entry device in the form of a keypad 1304 is disposed at said base.

Owing to the depth of the trough, a line of sight 1305 directly above the keypad 1304 allows a user to see the keypad 1304. However, a third party standing a little way behind or to one side of the user cannot see the keypad 1304 as their line of sight 1306 is restricted. In this way the information entered by a user is more likely to remain confidential.

Referring to FIG. 13B herein, is illustrated schematically an ATM comprising a trough with a keypad disposed on a wall of the trough. The ATM 1301 comprises the screen 1302 and a trough. The keypad 1306 is disposed on a wall of the trough substantially facing the screen 1302, and in a main plane substantially parallel to a main plane of the screen 1302. A reflective surface such as a mirror 1308 is disposed on an opposing wall of the trough, thereby allowing a user to view the mirror in their line of sight 1309 and view the reflection 1310 of the keypad. It is considered that by inverting the normal array of keys on the keypad 1307, the mirror image of the keypad 1307 will be apparent to the user, allowing him or her to easily enter data.

More that one mirror can be used to reflect the keypad if it is disposed at a different point in the trough 1303.

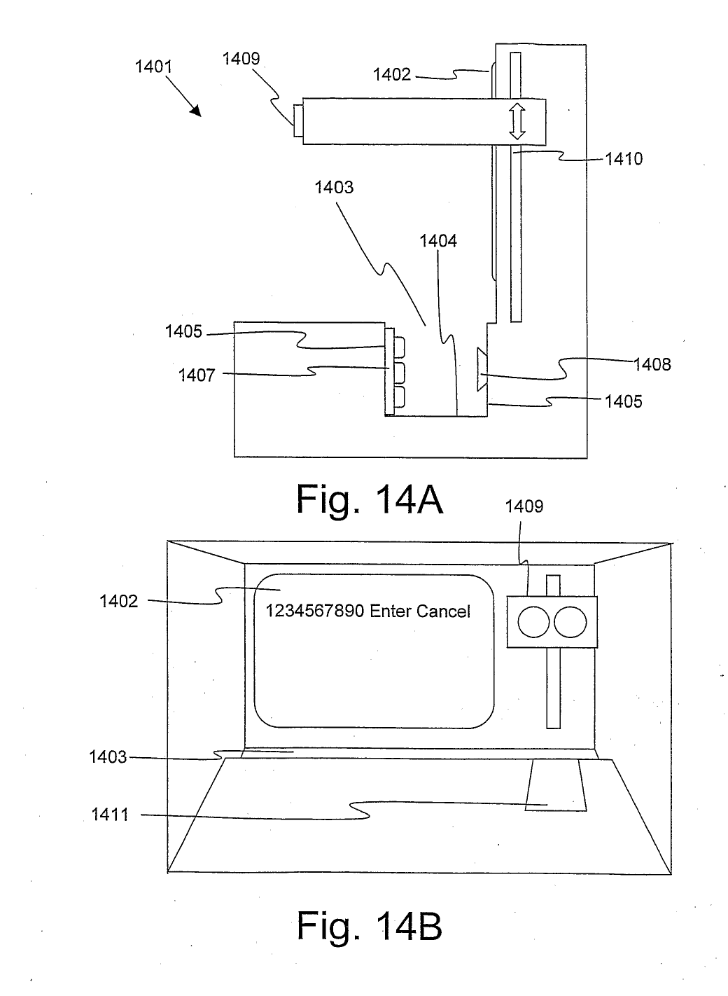

In a further specific embodiment, a viewing port can be provided to allow a user to see the keypad. Referring to FIG. 14 herein, there is illustrated schematically an ATM having a viewing port. FIG. 14A illustrates schematically a cross-section of an ATM having a viewing port. The ATM 1401 comprises a display device 1402, in the form of a screen. The display device 1402 is configured to display information to the user. The ATM further comprises a trough 1403 at the ATM, the trough having a base 1404 and side walls, a main plane of the base being substantially perpendicular to a main plane of the screen 1402. A first side wall 1405 has a main plane substantially parallel to the main plane of the screen 1402, and has a face substantially facing said screen. A second side wall 1406 also has a main plane substantially parallel to the main plane of the screen 1402 and is substantially facing the first side wall 1405.

A data entry device in the form of a keypad 1407 is disposed on the first side wall 1405 of the trough. The keypad 1407 is configured to allow the user to enter data, and is disposed on the first side wall 1405 to restrict the view of the keypad 1407.

A camera 1408 is disposed on the second side wall 1408 of the trough 1403, and is configured to capture an image of the keypad 1407. The camera 1408 is operatively connected to a viewing port 1409. The viewing port 1409 allows the user to see the image of the keypad 1407, and thereby see which keys are being pressed. The viewing port 1409 is configured so that only the user looking directly down the viewing port 1409 can see the image of the keypad 1407. In this way, no third party can see the image of the keypad 1407 whilst the user is operating the keypad 1407.

The viewing port 1409 is mounted on a slider 1410 that allows a user to adjust the height of the viewing port 1409.

Referring to FIG. 14B, there is illustrated schematically a perspective view of the ATM having a viewing port 1409. A marker 1411 is placed on a surface of the ATM adjacent the first side wall 1407 of the trough to illustrate to the user the location of the keypad 1407 and assist the user in positioning his or her hand in the correct place for operating the keypad.

The camera may be provided with an on/off switch to conserve energy. The camera 1409 defaults to an off mode, and if the user wishes to use the facility of the camera he or she may turn the camera to an on mode.

Alternatively, the camera may be configured to turn on in response to a hand being placed over the marker 1411, and to turn off again when the user's hand is removed from over the marker 1411.

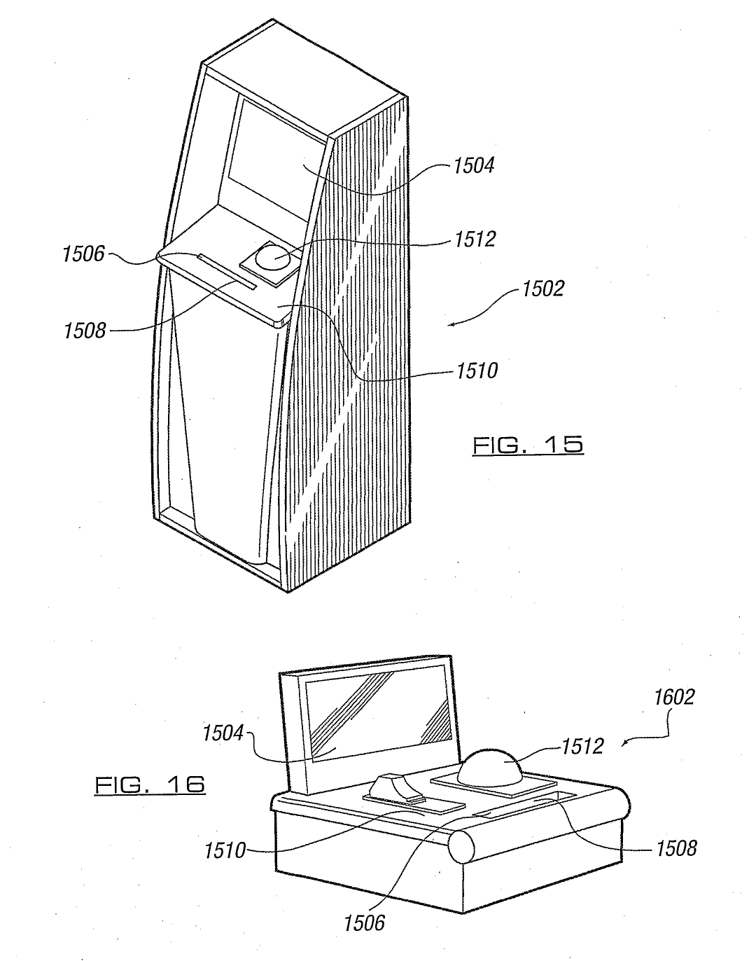

Referring to FIGS. 15 and 16, there is illustrated examples of an ATM machine 1502 and a card and pin input device 1602. The ATM machine 1502 and device 1602 includes a first display screen 1504 which is arranged in a conventional manner such that it is substantially vertical or at a small acute angle to the vertical and therefore can be viewed by a user in a horizontal orientation. A second display screen 1506 is provided in accordance with the present invention which is arranged in a substantially horizontal orientation, although it will be appreciated that small acute angles to the horizontal also still fall within the meaning of substantially horizontal.

Second display screen 1506 is recessed within a channel 1508 defined in surface 1510 of machine 1502. The side walls of channel 1508 are arranged substantially perpendicular to display screen 1506, such that a user looking through an opening arranged opposite to screen 1506 has to look in a substantially vertical direction downwardly in order to view data displayed on the display screen. As such, a third party standing behind the user would not be able to view the display screen 1506 due to the walls of channel 1508 restricting their view.

The data displayed on display screen 1506 typically relates to confidential data, such as a user's pin number, virtual keypad for inputting a pin number and/or the like. The arrangement of data on screen 1506 can be randomly moved and/or scrambled to prevent a third party from correlating movement of selection means to selection of a particular data item on the display screen.

Selection means in the form of a rotatably mounted ball member 1512 is mounted on surface 1510 to allow selection of data displayed on screen 1506 and/or on screen 1504. Ball member 1512 is typically rotatable in one of an arbitrary number of directions, such that a third party cannot easily correlate movement of the selector ball 1512 with movement of an indicator arrow on the display screens or selection of data on the display screen. Ball member 1512 can be depressed to allow selection of a data item on the display screen in addition to rotation of the ball member to move an indicator arrow around the display screen. Alternatively, or in addition, a further selection button can be provided to allow selection of one or more data items from screens 1506 and/or 1504.

The ATM can include any other features normally provided on an ATM machine, such as a credit card entry port, cash dispensing slot and/or the like. In addition, only a single display screen 1506 need be provided if required.

1. A data entry device, said device including display means for displaying data thereon and selection means for allowing a user to make one or more selections of data displayed on said display means, characterised in that the display means are arranged in a substantially horizontal orientation and are recessed within a cavity or channel means defined in said device, the walls of the cavity or channel means which define an opening through which a viewer views the display means being arranged substantially perpendicular to said display means.

2. A device according to claim 1 wherein the walls of the cavity or channel means are of sufficient height or depth to prevent a third party from viewing the display means from a side or distance from the device.

3. A device according to claim 1 wherein the selection means includes any or any combination of one or more dials, scrolling elements, buttons, sliders or switches.

4. A device according to claim 1 wherein the selection means are used to navigate and/or move an indicator on the display means between two or more different positions and/or are used to make a selection once the indicator is in a required location on said display means.

5. A device according to claim 1 wherein the selection means includes a selector element which is capable of undergoing movement in one of an arbitrary number of directions selected by the user.

6. A device according to claim 1 wherein the selection means includes a ball or hemispherical member which can be rotated in more than one direction to allow selection of data displayed on the display means.

7. A device according to claim 1 wherein the device forms part of or is associated with an automatic teller machine.

8. A device according to claim 1 wherein the device forms part of or is associated with a handle of a closure member or door.

9. A device according to claim 1 wherein the location of a particular data item displayed on the display screen is randomly changed after each use of the device by processing means provided in or associated with the device.

10. An automatic teller machine (ATM) having a data entry device, the ATM including a screen configured to display information, a card entry port, a hand rest and the data entry device including a keypad, the keypad including a plurality of keys, said keys being configured to allow a user to enter data, characterised in that said data entry device is disposed at said hand rest and substantially facing said screen, or disposed substantially at a lower surface of said hand rest, thereby restricting a view of said data entry device.

11. An ATM according to claim 10 wherein said hand rest comprises a bar.

12. An ATM according to claim 10 wherein said ATM includes a reflective surface, said reflective surface configured to allow a user to see said keypad.

13. An ATM according to claim 10 wherein said ATM includes a camera, said camera being configured to capture an image of said data entry device, a viewing port, said viewing port being operatively connected to said camera, and configured to display said captured image and wherein a view of said captured image is apparent to a single user only.

14. An ATM according to claim 10 wherein said ATM includes the data entry device is mounted at or on a pivoting drum, said entry device configured to move between a visible position and a concealed position substantially facing said screen.

15. An ATM according to claim 10 wherein said ATM includes at least one projecting stud disposed in proximity to a card entry port, said stud configured to restrict a fitting of a dummy cover to said port.

16. An ATM according to claim 15 wherein said stud comprises a trapezoidal cross section.

17. An ATM according to claim 15 wherein an upper surface of said stud is disposed substantially above said card entry port.

18. A handle for a closure member, said closure member including a locking mechanism, said handle including means for operating said locking mechanism, characterised in that said means for operating said locking mechanism is disposed on a surface of said handle, said surface of said handle substantially facing the closure member or facing away from a user of the closure member.

19. A handle according to claim 18 wherein said means for operating said locking mechanism includes a plurality of elements, said elements configured to co-operate in combination to operate said locking mechanism.

20. A handle according to claim 19 wherein said elements are selected from a set including any or any combination of one or more buttons, sliders, dials, switches or direction dials.

21. A handle according to claim 19 wherein said elements are configured to be operated sequentially.

22. A handle according to claim 19 wherein said elements are configured to be operated simultaneously.

23. A handle according to claim 18 wherein said handle further includes a projecting lug configured to partially cover said means for operating said locking mechanism.

24. A handle according to claim 18 wherein said means for operating said locking mechanism include tactile indictors, said tactile indicators configured to impart information about said means for operating said locking mechanism.

25. A handle according to claim 24 wherein said tactile indicators are chosen from a set including any or any combination of a raised profile, surface finish or raised Braille profile.

26. A handle according to claim 18 wherein said locking mechanism includes a bolt configured to selectively lock said closure member in a closed position.

27. A handle according to claim 18 wherein said locking mechanism includes means to selectively restrict operation of said handle.

28. A handle according to claim 18 wherein said means for operating said locking mechanism includes at least one mechanical actuator.

29. A handle according to claim 18 wherein said means for operating said locking mechanism includes at least one electronic actuator.

30. A handle according to claim 18 wherein a secondary device is provided and is configured to restrict operation of said locking mechanism unless said secondary device is actuated, said secondary device being selected from any or any combination of a button, a touch pad, a swipe card reader, a fob tag or key reader, identification technology, logistics or a proximity device such as a radio transmitter.

31. A handle for a closure member, said closure member having a locking mechanism including means for operating said locking mechanism and further including means to respond to a plurality of movements of said handle, and wherein said locking mechanism is configured to be operated in response to said plurality of movements of said handle corresponding with a predetermined plurality of movements of said handle.

32. A handle for a closure member according to claim 31 wherein said predetermined movements are selected from any or any combination of rotation of said handle about an axis substantially perpendicular to a main plane of said closure member, rotation of said handle about an axis substantially parallel to a main plane of said closure member or movement of said handle in a direction substantially perpendicular to a main plane of said closure member.

33. A handle for a closure member according to claim 31 wherein said means for operating said locking mechanism includes at least one mechanical actuator.

34. A handle for a closure member according to claim 31 wherein said means for operating said locking mechanism includes at least one electronic actuator.

35. A handle for a closure member including a combination lock, said combination lock being disposed at a surface of said handle substantially facing said closure member, and said combination lock configured to selectively operate a locking mechanism for said closure member.

36. A handle for a closure member according to claim 35 wherein said combination lock includes a plurality of elements, said elements selected from any or any combination of one or more buttons, sliders, switches, dials and/or direction dials.

37. A handle for a closure member according to claim 35 wherein said locking mechanism includes a bolt.

38. A handle for a closure member according to claim 35 wherein said locking mechanism includes means to selectively restrict operation of said handle.

39. A door comprising a locking mechanism, a handle, means for operating said locking mechanism, characterised in that said means for operating said locking mechanism is disposed at a surface of said handle, said surface of said handle substantially facing said door.

40. A door as claimed in claim 39 wherein said means for operating said locking mechanism includes a plurality of elements, said elements configured to co-operate in combination to operate said locking mechanism.

41. A door as claimed in claim 39 wherein said elements are selected from a set including any or any combination of one or more buttons, sliders, dials, switches and/or direction dials.

42. A door as claimed in claim 39 wherein said elements are configured to be operated sequentially.

43. A door as claimed in claim 39 wherein said elements are configured to be operated simultaneously.

44. A door as claimed in claim 39 wherein said means for operating said locking mechanism includes means to respond to a plurality of movements of said handle, wherein said locking mechanism is configured to be operated in response to said plurality of movements of said handle corresponding with a predetermined plurality of movements of said handle.

45. A door as claimed in claim 44 wherein said predetermined movements are selected from any or any combination of rotation of said handle about an axis substantially perpendicular to a main plane of said closure member, rotation of said handle about an axis substantially parallel to a main plane of said closure member or movement of said handle in a direction substantially perpendicular to a main plane of said closure member.
